(19) United States
(12) Patent Application Publication
(10) Pub. No.: US 2026/0357636 A1
(43) Pub. Date: Nov. 12, 2026

(54) SEAMLESS PASSIVE ENTRY FOR GARAGE DOORS

(71) Applicant: GM GLOBAL TECHNOLOGY OPERATIONS LLC, Detroit, MI (US)

(72) Inventors: Mohamed A. Layouni, Macomb, MI (US); Ahmed F. Al Alawy, Canton, MI (US); Mustafa Hamada Chmeiseh, Shelby Township, MI (US)

(73) Assignee: GM GLOBAL TECHNOLOGY OPERATIONS LLC, Detroit, MI (US)

(21) Appl. No.: 19/202,590

(22) Filed: May 8, 2025

(51) Int. Cl. E05F 15/77; E05F 15/73

(52) U.S. Cl. CPC E05F 15/77; E05F 15/73; E05F 2015/765; E05Y 2900/106

(57) ABSTRACT

In exemplary embodiments, methods and systems are provided for controlling automated operation of a garage door of a garage. In an embodiment, one or more sensors are configured to obtain sensor data as to a vehicle in proximity to the garage door. A processor is coupled to the one or more sensors, and is configured to at least facilitate performing authentication of the vehicle as being associated with the garage, using the sensor data; performing ranging of the vehicle in proximity to the garage, using the sensor data; and automatically opening and closing the garage door, via instructions provided by the processor to an actuator and that are implemented via the actuator, based on the authentication and the ranging of the vehicle based on the sensor data.

### INTRODUCTION

The technical field generally relates to garage doors and, more specifically, to methods and systems for automating the opening and closing of garage doors.

Certain garages today are capable of having their doors opened and closed by vehicles that are to be stored in the garages. However, existing techniques for opening and closing garage doors may not always be optimal.

Accordingly, it is desirable to provide improved methods and systems for automating opening and closing of garage doors with respect to vehicles that utilize the garage. Furthermore, other desirable features and characteristics of the present disclosure will become apparent from the subsequent detailed description and the appended claims, taken in conjunction with the accompanying drawings and the foregoing technical field and background.

### SUMMARY

In an exemplary embodiment, a method is provided for controlling automated operation of a garage door of a garage, the method including obtaining, via one or more sensors, sensor data as to a vehicle in proximity to the garage door; performing authentication of the vehicle as being associated with the garage, via a processor coupled to the one or more sensors and using the sensor data; performing ranging of the vehicle in proximity to the garage, via the processor using the sensor data; and automatically opening and closing the garage door, via instructions provided by the processor to an actuator and that are implemented via the actuator, based on the authentication and the ranging of the vehicle via the processor based on the sensor data.

Also in an exemplary embodiment, the one or more sensors include sensors from both the vehicle and the garage.

Also in an exemplary embodiment, the method further includes determining, via the processor using the sensor data and based on the ranging, whether the vehicle is disposed in the garage; automatically opening the garage based on inside opening criteria, via instructions provided by the processor to the actuator, when it is determined that the vehicle is disposed in the garage; automatically opening the garage based on outside opening criteria that is different from the inside opening criteria, via instructions provided by the processor to the actuator, when it is determined that the vehicle is disposed outside the garage; automatically closing the garage based on inside closing criteria, via instructions provided by the processor to the actuator, when it is determined that the vehicle is disposed in the garage; and automatically closing the garage based on outside closing criteria that is different from the inside closing criteria, via instructions provided by the processor to the actuator, when it is determined that the vehicle is disposed outside the garage.

Also in an exemplary embodiment, the inside opening criteria is based on one or more security requirements of the vehicle; and the outside opening criteria is based on the vehicle being in proximity to the garage door in addition to one or more indications of intent of the vehicle or a user of the vehicle to enter the garage.

Also in an exemplary embodiment, the one or more security requirements of the inside opening criteria include a motor of the vehicle being turned on while the vehicle is inside the garage; and the one or more indications of intent of the outside opening criteria include the vehicle being in a region of interest in a driveway in proximity to the garage.

Also in an exemplary embodiment, the one or more indications of intent of the outside opening criteria further include the vehicle moving in a pattern from a roadway toward the garage via the driveway.

Also in an exemplary embodiment, the one or more indications of intent of the outside opening criteria further include the user of the vehicle taking one or more predefined actions with respect to a garage opening button, flashing of headlights of the vehicle, or both.

Also in an exemplary embodiment, the inside closing criteria are based on one or more security requirements of the vehicle, including whether a motor of the vehicle is turned off; and the outside closing criteria is based on the vehicle having exited the garage and travelling outside a region of interest in proximity to the garage.

Also in an exemplary embodiment, the one or more security requirements of the inside closing criteria further include doors of the vehicle being closed, locked, or both.

In another exemplary embodiment, a system for controlling automated operation of a garage door of a garage, the system including one or more sensors and a processor. The one or more sensors are configured to obtain sensor data as to a vehicle in proximity to the garage door. The processor is coupled to the one or more sensors and that is configured to at least facilitate performing authentication of the vehicle as being associated with the garage, using the sensor data; performing ranging of the vehicle in proximity to the garage, using the sensor data; and automatically opening and closing the garage door, via instructions provided by the processor to an actuator and that are implemented via the actuator, based on the authentication and the ranging of the vehicle based on the sensor data.

Also in an exemplary embodiment, the one or more sensors include sensors from both the vehicle and the garage.

Also in an exemplary embodiment, the processor is further configured to at least facilitate determining, using the sensor data and based on the ranging, whether the vehicle is disposed in the garage; automatically opening the garage based on inside opening criteria, via instructions provided by the processor to the actuator, when it is determined that the vehicle is disposed in the garage; automatically opening the garage based on outside opening criteria that is different from the inside opening criteria, via instructions provided by the processor to the actuator, when it is determined that the vehicle is disposed outside the garage; automatically closing the garage based on inside closing criteria, via instructions provided by the processor to the actuator, when it is determined that the vehicle is disposed in the garage; and automatically closing the garage based on outside closing criteria that is different from the inside closing criteria, via instructions provided by the processor to the actuator, when it is determined that the vehicle is disposed outside the garage.

Also in an exemplary embodiment, the inside opening criteria is based on one or more security requirements of the vehicle; and the outside opening criteria is based on the vehicle being in proximity to the garage door in addition to one or more indications of intent of the vehicle or a user of the vehicle to enter the garage.

Also in an exemplary embodiment, the one or more security requirements of the inside opening criteria include a motor of the vehicle being turned on while the vehicle is inside the garage; and the one or more indications of intent of the outside opening criteria include the vehicle being in a region of interest in a driveway in proximity to the garage.

Also in an exemplary embodiment, the one or more indications of intent of the outside opening criteria further include the vehicle moving in a pattern from a roadway toward the garage via the driveway.

Also in an exemplary embodiment, the one or more indications of intent of the outside opening criteria further include the user of the vehicle taking one or more predefined actions with respect to a garage opening button, flashing of headlights of the vehicle, or both.

Also in an exemplary embodiment, the inside closing criteria are based on one or more security requirements of the vehicle, including whether a motor of the vehicle is turned off; and the outside closing criteria is based on the vehicle having exited the garage and travelling outside a region of interest in proximity to the garage.

Also in an exemplary embodiment, the one or more security requirements of the inside closing criteria further include doors of the vehicle being closed, locked, or both.

In another exemplary embodiment, a system is provided that includes a garage, a wireless communications system, and a vehicle. The garage includes a garage door, an actuator configured to open and close the garage door; and a garage sensor array configured to obtain garage sensor data. The vehicle is configured to be coupled to the garage via the wireless communications system. The vehicle includes a body; a plurality of doors; a plurality of wheels; a drive system including a motor and configured to move the body via the plurality of wheels; and a vehicle sensor array that is configured to obtain vehicle sensor data. The garage, the vehicle, or both further include one or more processors that are coupled to the garage sensor array and that are configured to at least facilitate performing authentication of the vehicle as being associated with the garage, using the garage sensor data and the vehicle sensor data; performing ranging of the vehicle in proximity to the garage, using the garage sensor data and the vehicle sensor data; determining, using the sensor data and based on the ranging, whether the vehicle is disposed in the garage; and automatically opening and closing the garage door, via instructions provided by the one or more processors to the actuator and that are implemented via the actuator, based on the authentication and the ranging of the vehicle based on the sensor data, including by automatically opening the garage based on inside opening criteria based on one or more security requirements of the vehicle including the motor of the vehicle being turned off, via instructions provided by the one or more processors to the actuator, when it is determined that the vehicle is disposed in the garage; automatically opening the garage based on outside opening criteria that is different from the inside opening criteria and that is based on the vehicle being in proximity to the garage door in addition to one or more indications of intent of the vehicle or a user of the vehicle to enter the garage, via instructions provided by the one or more processors to the actuator, when it is determined that the vehicle is disposed outside the garage; automatically closing the garage based on inside closing criteria, via instructions provided by the one or more processors to the actuator based on the one or more security requirements of the vehicle, including the motor of the vehicle being turned off, when it is determined that the vehicle is disposed in the garage; and automatically closing the garage based on outside closing criteria that is different from the inside closing criteria based on the vehicle having exited the garage and travelling outside a region of interest in proximity to the garage, via instructions provided by the one or more processors to the actuator, when it is determined that the vehicle is disposed outside the garage.

Also in exemplary embodiment, the one or more indications of intent of the outside opening criteria further include the vehicle moving in a pattern from a roadway toward the garage via the driveway, and the user of the vehicle taking one or more predefined actions with respect to a garage opening button, flashing of headlights of the vehicle, or both; and the one or more security requirements of the inside closing criteria further include the plurality of doors of the vehicle being closed, locked, or both.

### DESCRIPTION OF THE DRAWINGS

The present disclosure will hereinafter be described in conjunction with the following drawing figures, wherein like numerals denote like elements, and wherein:

FIG. 1 is a functional block diagram of a system that includes a vehicle along with a garage having a garage door that is opened and closed via a control system of the vehicle, in accordance with exemplary embodiments;

FIG. 2 is a flowchart of a process for automatically opening and closing garage doors with respect to a vehicle that utilizes the garage, and that can be implemented in connection with the system of FIG. 1, including the vehicle and control system thereof, in accordance with exemplary embodiments; and

FIGS. 3-11 depict exemplary implementations of the process of FIG. 2, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

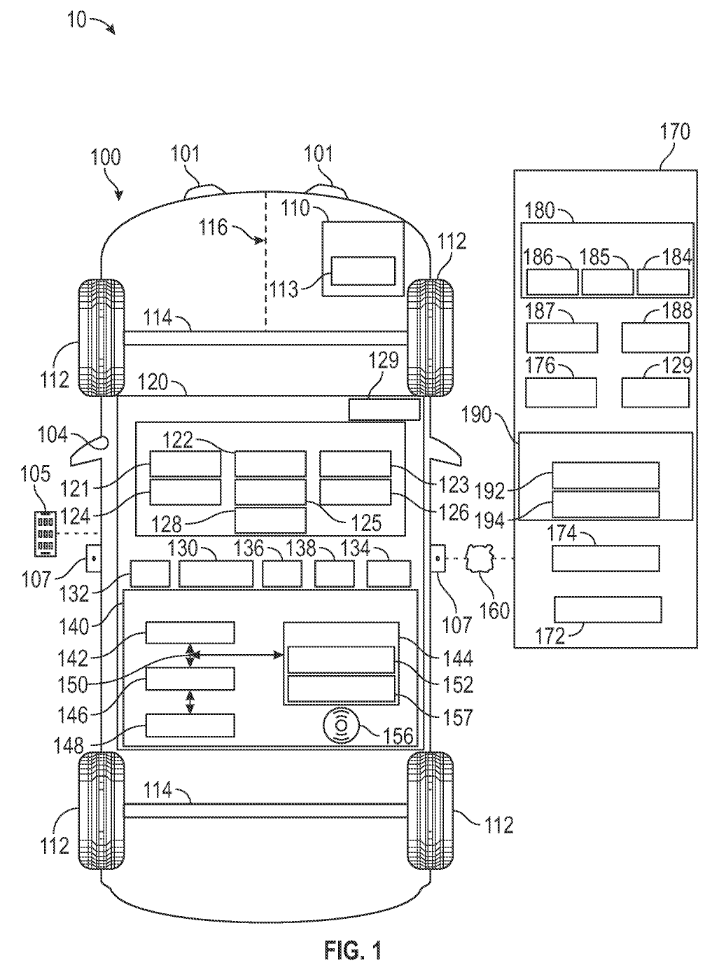

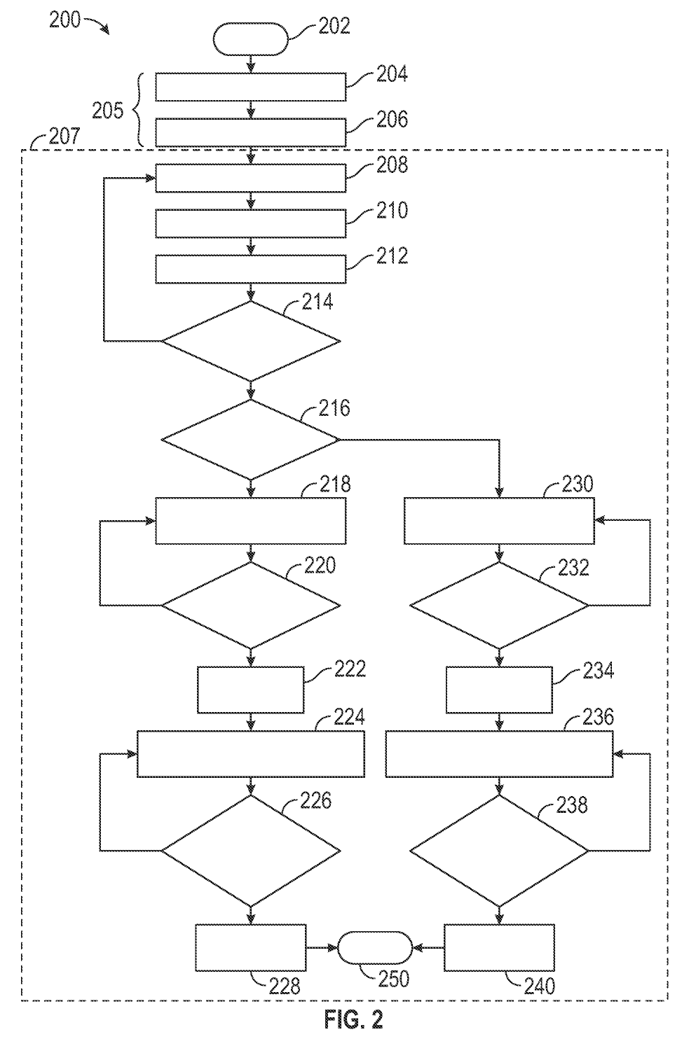

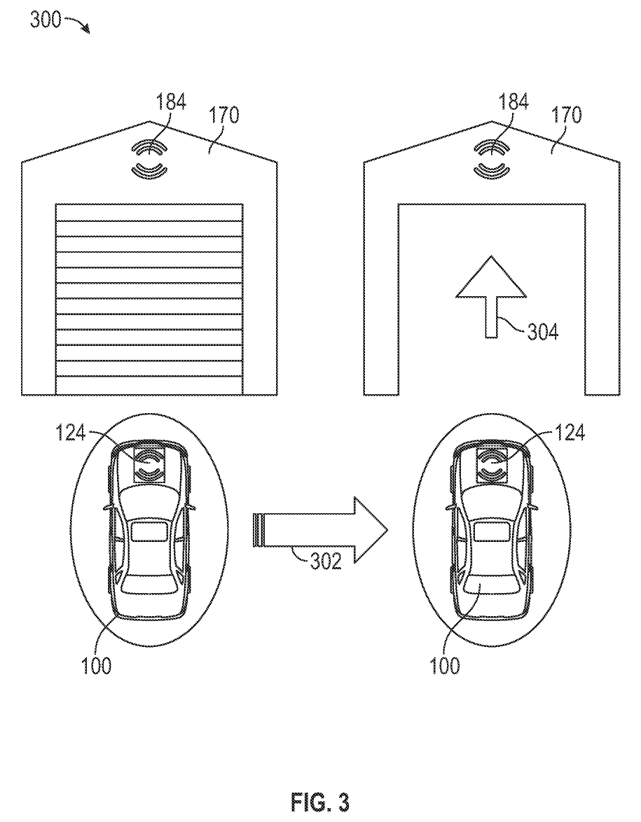

FIG. 1 illustrates a system 10, according to an exemplary embodiment. As described in greater detail further below, the system 10 includes a vehicle 100 and a garage 170 having a door 172, in accordance with an exemplary embodiment. As described in greater detail further below, in various embodiments the vehicle 100 includes a control system 102 that controls opening and closing of the door 172 of the garage 170 (including in a passive manner when the vehicle 100 approaches the garage 170 and various other conditions are satisfied), in accordance with the process 200 described further below in connection with the flowchart of FIG. 2 and the implementations of FIGS. 3-11.

Also as depicted in FIG. 1, in various embodiments the system 10 further includes an electronic device 105 (e.g., of a user of the vehicle 100) along with a communications network 160 that facilitates communications between the vehicle 100 and the garage 170, and in certain embodiments also with the electronic device 105. In an exemplary embodiment the electronic device 105 includes a smart phone, computer, and/or other electronic device of a driver and/or other user of the vehicle. Also in various embodiments, the communications network 160 comprises one or more wireless communications networks (e.g., including one or more short range wireless, medium range wireless, cellular, satellite, and/or other wireless networks) for communication by and between the vehicle 100, the electronic device 105, and the garage 170.

In various embodiments, the vehicle 100 includes an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise another type of vehicle, such as aircraft, spacecraft, watercraft, and so on.

The vehicle 100 includes a body 104 that is arranged on a chassis 106. The body 104 substantially encloses other components of the vehicle 100. The body 104 and the chassis 106 may jointly form a frame. One or more doors 107 are formed in the body, and allow for a driver and passengers to enter into and exit from the vehicle 100. The vehicle 100 also includes a plurality of wheels 112. The wheels 112 are each rotationally coupled to the chassis 106 near a respective corner of the body 104 to facilitate movement of the vehicle 100. In one embodiment, the vehicle 100 includes four wheels 112, although this may vary in other embodiments (for example for trucks and certain other vehicles).

As depicted in FIG. 1, in exemplary embodiments, a drive system 110 is mounted on the chassis 106, and drives the wheels 112, for example via axles 114. In certain embodiments, the drive system 110 comprises a propulsion system. In certain exemplary embodiments, the drive system 110 comprises a motor 113, such as an internal combustion engine and/or an electric motor/generator, coupled with a transmission thereof. In certain embodiments, the drive system 110 may vary, and/or two or more drive systems 110 may be used. Also in exemplary embodiments, the drive system 110 controls propulsion of the vehicle 100 via inputs provided by a driver (i.e., via an accelerator pedal) and/or automatically via instructions provided by the control system 102.

In various embodiments, as noted above, the control system 102 controls opening and closing of the door 172 of the garage 170. In various embodiments, the control system 102 controls automatically opening and closing the garage door 172 based on communications with the garage 170 and the electronic device 105, and based on the vehicle 100 approaching the garage 170 in addition to various other factors and conditions in accordance with the process 200 of FIG. 2 and the implementations of FIGS. 3-11, as described in greater detail further below.

As depicted in FIG. 1, in various embodiments, the control system 102 includes a sensor array 120 and a controller 140, as described in greater detail below. Also as depicted in FIG. 1, in various embodiments the control system 102 also includes a display system 130, a transceiver 132, a location system 134, a garage door button 136, and/or other input devices 138, also as described in greater detail below.

In various embodiments, the sensor array 120 includes various sensors that obtain sensor data as to the vehicle 100 (and in certain embodiments also as to the garage 170), including for use in opening and closing the garage door 172. In the depicted embodiment, the sensor array 120 includes one or more input sensors 121, engine sensors 122, door sensors 123, ultra-wideband (UWB) sensors 124, radio frequency (RF) sensors 125, and short range wireless (SRW) sensors 126. In certain embodiments, the sensor array 120 may also include one or more other sensors 128.

In various embodiments, the one or more input sensors 121 receive inputs from a driver or other user of the vehicle 100. In certain embodiments, the inputs include the driver’s instructions for automatically opening and closing the garage door 172 (e.g., via a dedicated button, a display screen, and/or other device). Also in certain embodiments, the inputs may also include other driver actions and instructions, such as for turning on the motor (e.g., engine) 113, operating headlights 101 of the vehicle 100, and so on. In various embodiments, sensor data from the input sensors 121 is utilized by the control system 102 for determining the conditions for automatically opening and closing the garage door 172.

In various embodiments, the engine sensors 122 detect a state of the motor (e.g., engine) 113, including as to when the motor 113 is turned off and on. While the term “engine sensors” is utilized, it will be appreciated that this may also include sensors for other types of motors 113 (e.g., electric motors), and so on. In various embodiments, sensor data from the input sensors 121 is also utilized by the control system 102 for determining the conditions for automatically opening and closing the garage door 172.

In various embodiments, the door sensors 123 detect one or more states of one or more of the doors 107 of the vehicle 100. In various embodiments, the door sensors 123 obtain sensor data as to whether the doors 107 are opened or closed, and further as to whether the doors 107 are locked or unlocked. In various embodiments, sensor data from the door sensors 123 is also utilized by the control system 102 for determining the conditions for automatically opening and closing the garage door 172.

In various embodiments, ultra-wideband (UWB) 124, radio frequency (RF) sensors 125, and/or short range wireless (SRW) 126 sensors are utilized in combination with respective sensors of the sensors array 180 of the garage 170 (described further below), including for detecting a proximity and movement of the vehicle 100 with respect to the garage 170 (including the garage door 172 thereof), and in various embodiments for communication with the garage 170 and/or the respective sensors of the sensor array 180 thereof. In various embodiments, sensor data from the ultra-wideband (UWB) 124, radio frequency (RF) sensors 125, and/or short range wireless (SRW) 126 sensors are also utilized by the control system 102 for determining the conditions for automatically opening and closing the garage door 172.

In addition, in certain embodiments, a link 129 is formed between one or more sensors of the sensor array 120 of the vehicle 100 (including one or more of the ultra-wideband (UWB) 124, radio frequency (RF) sensors 125, and/or short range wireless (SRW) 126 sensors thereof) and one or more sensors of the sensor array 180 of the garage 170, for determining the conditions for automatically opening and closing the garage door 172.

Also in various embodiments, the other sensors 128 may include one or more other detection and/or communication sensors of the vehicle 100, among other possible sensors of the sensor array 120. In certain embodiments, the other sensors 128 may include one or more medium range wireless (MRW) sensors for detecting proximity to and communicating with the garage 170. In certain embodiments, the other sensors 128 may also include one or more detection sensors such as one or more exterior cameras, radar, Lidar, sonar, infrared, and/or other detection sensors. Also in certain embodiments, the other sensors 128 may also include one or more sensors that are part of and/or coupled to one or more other vehicle devices and/or systems, such as that detect when the headlights 101 are turned on or off, and the like.

In certain embodiments, the display system 130 is configured to provide information, displays, and related information for the driver or other user, and in certain embodiments to receive inputs from the driver or other user, including pertaining to opening and closing of the garage door 172. In various embodiments, the display system 130 includes a visual component including a display screen that provides visual notifications for the driver and that facilitates receiving inputs from the driver. In certain embodiments, the display system 130 may also include one or more audio components (e.g., including a speaker and/or microphone) that provides audio notifications for the driver and/or that receives audio inputs from the driver, and/or one or more other components, such as a haptic component that provides one or more haptic notifications for the driver (e.g., by vibrating a seat of the driver), and so on.

In certain embodiments, the transceiver 132 is configured to communicate with the garage 170 via the one or more communications networks 160, in a wireless manner, including as to conditions and commands for automatically opening and closing the garage door 172. In certain embodiments, the transceiver 132 similarly communicates in a wireless manner with the electronic device 105 (e.g., a smart phone of a user of the vehicle 100), also including conditions and commands for automatically opening and closing the garage door 172.

In certain embodiments, the location system 134 obtains information as to a geographic location of the vehicle 100. In certain embodiments, the location system 134 comprises and/or is part of or coupled to a satellite-based system, such as a global positioning system (GPS) as part of a navigation system for the vehicle 100.

In certain embodiments, the garage door button 136 receives manual inputs and instructions from a driver or other user of the vehicle 100 as to opening and closing of the garage door 172. In certain embodiments the garage door button 136 may be fixed to the vehicle 100, whereas in certain other embodiments the garage door button 136 may be movable by the user into and out of the vehicle 100. Also in various embodiments, the garage door button 136 may be a physical button (e.g., a button, clicker, or the like) or a virtual or “soft” button (e.g., as part of a display screen or the like).

In certain embodiments, the other input devices 138 allow for the driver or other user to provide additional inputs for operation of the vehicle 100 and/or more systems and/or devices thereof. In certain embodiments, the other input devices 138 are utilized by the driver or other user for operating the headlights 101 and the motor 113, including for turning these devices on and off, and the like.

In various embodiments, the controller 140 is coupled to the sensor array 120. In certain embodiments, the controller 140 is also coupled to the display system 130, the transceiver 132, the location system 134, the garage door button 136, the other input devices 138, and/or one or more other vehicle systems. Also in various embodiments, the controller 140 comprises a computer system (also referred to herein as computer system 140), and includes a processor 142, a memory 144, an interface 146, a storage device 148, and a computer bus 150. In various embodiments, the controller (or computer system) 140 provides, among other functionality, for automated vehicle control, including for automatically opening and closing the garage door 172 for the vehicle 100. In various embodiments, the controller 140 provides these and other functions in accordance with the steps of the process 200 of FIGS. 2 and the implementations of FIGS. 3-11.

In various embodiments, the controller 140 (and, in certain embodiments, the control system 102 itself) is disposed within the body 104 of the vehicle 100. In one embodiment, the control system 102 is mounted on the chassis 106. In certain other embodiments, the controller 140 and/or control system 102 and/or one or more components thereof may be disposed outside the body 104, for example on a remote server, in the cloud, or other device.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In various embodiments, the processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the process 200 of FIGS. 2 and the implementations of FIGS. 3-11.

The memory 144 can be any type of suitable memory. For example, the memory 144 may include various types of dynamic random access memory (DRAM) such as synchronous dynamic random access memory (SDRAM), the various types of static RAM (SRAM), and the various types of non-volatile memory, such as programmable read-only memory (PROM) and flash. In certain examples, the memory 144 is located on and/or co-located on the same computer chip as the processor 142. In the depicted embodiment, the memory 144 stores the above-referenced program 152 along with stored values 157 (e.g., threshold values for the process 200 of FIG. 2 and the implementations of FIGS. 3-11 in various embodiments).

The interface 146 allows communication to the computer system of the controller 140, for example from a system driver and/or another computer system, and can be implemented using any suitable method and apparatus. In one embodiment, the interface 146 obtains the various data from the sensor array 120, among other possible data sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of one or more processes of the present disclosure, such as the steps of the process 200 of FIGS. 2 and the implementations of FIGS. 3-11. In another exemplary embodiment, the program product may be directly stored in and/or otherwise accessed by the memory 144 and/or a disk (e.g., disk 156), such as that referenced below.

The bus 150 serves to transmit programs, data, status and other information or signals between the various components of the computer system of the controller 140. The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

With continued reference to FIG. 1, in various embodiments the garage 170 includes the above-referenced door 172 and sensor array 180, in addition to one or more actuators 174, a transceiver 176, and a computer system 190.

In various embodiments, the actuators 174 open and close the garage door 172, upon receiving instructions to do so from the control system 102 of the vehicle 100 and/or the computer system 190 of the garage 170.

Also in various embodiments, the sensor array 180 includes sensors that obtain sensor data as to position and/or movement of the vehicle 100 with respect to the garage 170 (including with respect to the garage door 172) and in certain embodiments that communicate with respective sensors of the sensor array 120 of the vehicle 100. In various embodiments, the sensor array 180 includes, among other possible sensors, one or more ultra-wideband (UWB) sensors 184, radio frequency (RF) sensors 185, and/or short range wireless (SRW) sensors 186 (e.g., in certain embodiments, similar to respective corresponding sensors of the sensor array 120 of the vehicle 100). In various embodiments, the sensor array 180 may also include one or more other sensors, such as by way of example one or more cameras, radar, and/or other detection sensors (e.g., similar to the sensor array 180 of the vehicle 100).

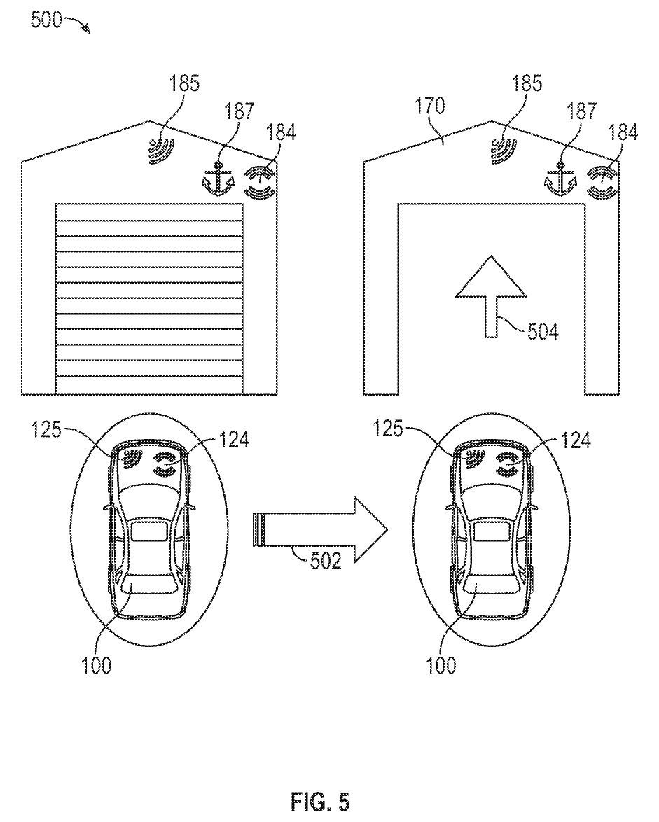

Similar to the discussion above, in various embodiments a link 129 is formed between sensors of the sensor array 180 of the garage 170 and sensors of the sensor array 120 of the vehicle 100. Also in various embodiments, one or more anchors 187 and/or bridges 188 are also implemented in connection with the garage 170 and the sensor array 180 thereof, including for communication with the vehicle 100 and the sensor array 120 thereof, and including as depicted in particular implementations of FIGS. 5-12 and/or as described further below in connection therewith.

In various embodiments, the transceiver 176 is configured to communicate with the vehicle 100, including the transceiver 132 thereof, via the communications network 160.

Also in certain embodiments, the computer system 190 controls functionality of the garage 170, including automatically opening and closing the garage door 172 and determinations pertaining thereto, including in certain embodiments in coordination with the control system 102 of the vehicle 100. In certain embodiments, the computer system 190 of the garage 170 includes a processor 192, a memory 194, and/or other components with similar functionality as the computer system 140 of the vehicle 100. In certain other embodiments, the garage 170 may not have a computer system 190 with a processor 192 and memory 194, and/or in certain embodiments such determinations may be made in whole or in part by the computer system 140 of the vehicle 100, including the processor 142 thereof.

FIG. 2 is a flowchart of a process 200 for controlling automated garage door opening and closing, in accordance with an exemplary embodiment. In various embodiments, the process 200 can be implemented in connection with the vehicle 100 and control system 102 thereof of FIG. 1, along with the garage 170 and garage door 172 thereof, along with other components of the system 10 of FIG. 1. The process 200 is described below in connection with FIGS. 3-11, which depict exemplary implementations of the process 200.

In various embodiments, the process 200 begins at 202. In certain embodiments, the process 200 begins during an initialization of the vehicle 100 (and/or components thereof) with garage 170 (and/or components thereof). In certain embodiments, the process 200 also may begin each time the vehicle 100 is being operated or about to be operated and/or is in proximity to the garage 170. In one embodiment, the steps of the process 200 are performed continuously throughout operation of the vehicle 100.

As depicted in FIG. 2, in various embodiments an initial pairing is performed (step 204). In certain embodiments, an initial pairing is performed between the vehicle 100 and the garage 170. Specifically, in certain embodiments, the initial pairing is performed between one or more of the sensors of the sensor array 120 of the vehicle 100 (e.g., one or more UWB sensors 124, RF sensors 125, and/or SRW sensors 126 thereof) and one or more sensors of the sensor array 180 of the garage 170 (e.g., one or more UWB sensors 184, RF sensors 185, and/or SRW sensors 186 thereof). In certain embodiments, the initial pairing of step 204 is performed the first time that the vehicle 100 and the garage 170 encounter one another, and/or the first time that respective sensors of the sensor array 120 of the vehicle 100 and respective sensors of the sensor array 180 of the garage 170 encounter one another.

In various embodiments, initial code learning is performed (step 206). In various embodiments, the initial code learning is performed between respective sensors of the sensor array 120 of the vehicle 100 and respective sensors of the sensor array 180 of the garage 170 (and/or in certain embodiments between respective processors 142, 192 of the vehicle 100 and the garage 170). In addition, as part of steps 204 and/or 206, a link is generated between the sensors of the respective sensor arrays 120, 180, forming the link 129 that is depicted in FIG. 1 and described above in connection therewith.

In various embodiments, steps 204 and 206 as described above are part of a combined step (or sub-process) 205 that is performed initially when the vehicle 100 and the garage 170 (and/or respective sensors thereof) are first introduced to one another. Also in various embodiments, subsequently, whenever the vehicle 100 is in operation and/or is disposed in proximity to the garage 170, remaining steps 208-250 of the process 200 of FIG. 2 (corresponding to sub-process 207) are performed.

In various embodiments, sensor data is obtained (step 208). Specifically, in various embodiments, sensor data is obtained from each of the sensors of the sensor array 120 of the vehicle 100 and the sensor array 180 of the garage 170. In various embodiments, this includes various inputs from a driver or other user of the vehicle 100 (including as to operation of the motor 113 and headlights 101 of the vehicle 100, as well as preferences and instructions for automatically opening and closing the garage door 172), as well as data pertaining to operation, location, and movement of the vehicle 100 with respect to the garage door 172.

In various embodiments, authentication is performed (step 210). Specifically, in various embodiments, authentication is performed between the vehicle 100 and the garage 170, including for determining that the vehicle 100 is recognized as being associated with the garage 170, and vice versa. In various embodiments, the authentication is performed via one or both of the processors 142 and/or 192 of FIG. 1 using the sensor data from the sensor arrays 120 and/or 180 along with related communications between the vehicle 100 and the garage 170 via their respective transceivers 132, 176 using the communications network 160.

Also in various embodiments, ranging is performed (step 212). Specifically, in various embodiments, ranging is performed between the vehicle 100 and the garage 170, including for monitoring a position and movement of the vehicle 100 with respect to the garage 170. In certain embodiments, the ranging is performed for the position and movement of the vehicle 100 with respect to the garage door 172 via one or both of the processors 142 and/or 192 of FIG. 1 using the sensor data from the sensor arrays 120 and/or 180 along with related communications between the vehicle 100 and the garage 170 via their respective transceivers 132, 176 using the communications network 160.

In various embodiments, a determination is made as to whether the vehicle 100 is authenticated nearby the garage 170 (step 214). In various embodiments, during step 214 a determination is made by one or both of the processors 142 and/or 192 as to whether the vehicle 100 has been successfully authenticated with the garage 170 (and/or vice versa in certain embodiments) at a location that is nearby the garage 170 (i.e., within a predetermined distance thereof) during the authentication of step 210 and the ranging of step 212.

In various embodiments, if it is determined in step 214 that the vehicle 100 has not been determined to be authenticated nearby the garage, then the process returns to step 208, as sensor data continues to be collected in a new iteration. In various embodiments, steps 208-214 thereafter repeat in new iterations until a determination is made in a subsequent iteration of step 214 that the vehicle 100 has been determined to be authenticated nearby the garage 170.

In various embodiments, once it is determined in step 214 that the vehicle 100 has been determined to be authenticated nearby the garage 170, then a determination is made as to whether the vehicle 100 is disposed inside the garage (step 216). In various embodiments, this determination is made by one or both of the processors 142 and/or 192 using the sensor data of step 208 from sensors of the sensor array 180 and/or 180 of FIG. 1, and in accordance with the ranging of step 212.

In various embodiments, if it is determined in step 216 that the vehicle 100 is physically disposed inside the garage 170, then one or more inside opening criteria are examined (step 218). Specifically, in various embodiments, during step 218, one or both of the processors 142 and/or 192 utilize sensor data of step 208 from sensors of the sensor array 180 and/or 180 to examine conditions for automated opening of the garage door 172 while the vehicle 100 is disposed within the garage 170.

In various embodiments, the inside opening criteria of step 218 include determinations as to whether one or more safety conditions are satisfied. Specifically, in certain embodiments, the inside opening criteria include whether an engine (e.g., the motor 113 of FIG. 1 is turned on). In various embodiments, this may be determined via the engine sensors 122 of FIG. 1, and/or by the processor 142 of FIG. 1 based on sensor data obtained via the engine sensors 122. Also in various embodiments, the inside opening criteria of step 218 may include one or more other types of conditions, such as a particular day of the week and time of the day in which the vehicle 100 is usually taken out of the garage 170 for a vehicle drive (e.g., near the beginning of the workday in one example), and so on.

In various embodiments, a determination is made as to whether the inside opening criteria are met (step 220). In various embodiments, this determination is made by one or both of the processors 142 and/or 192 of FIG. 1 based on the determinations of step 220. For example, in one embodiment, if it is determined that the motor 113 of the vehicle 100 is turned on, then the inside opening criteria is determined to be satisfied. Also in various embodiments, if it is determined that a current day of the week and time of day corresponds to a usual day and time for the vehicle 100 to exit the garage for a vehicle drive, then the inside opening criteria is likewise determined to be satisfied, and so on.

In various embodiments, if it is determined in step 220 that the inside opening criteria is not satisfied, then in various embodiments the process 200 returns to step 218, and steps 218-220 thereafter repeat in new iterations until a determination is made during an iteration of step 220 that the inside opening criteria is satisfied.

Conversely, in various embodiments, once it is determined in an iteration of step 220 that the inside opening criteria is satisfied, then the garage door is opened (step 222). Specifically, in various embodiments, during step 222, the garage door 172 of FIG. 1 is opened by the actuators 174 of FIG. 1 in accordance with instructions provided by one or both processors. In certain embodiments, the instructions are provided by the processor 142 of the vehicle 100. In certain other embodiments, the instructions are instead provided by the processor 192 of the garage 170.

In certain embodiments, before the garage door is opened, the processor(s) may allow a user of the vehicle 100 to override the garage door automated opening action, for example by providing a notice to the user via the display system 130 of the vehicle 100 and/or via the user electronic device 105 (e.g., smart phone) of the user, and providing the user with the opportunity to confirm and/or override the automated door opening action at the user’s discretion in certain embodiments (and with the processor(s) aborting the automated door opening action if an override is provided by the user, for example, via the display system 130, the user’s electronic device 105, and/or via a voice command of the user, or the like).

In various embodiments, once the garage door 172 is opened, one or more further criteria are examined as to closing the garage door 172 (step 224). Specifically, in various embodiments, during step 224, one or both of the processors 142 and/or 192 utilize additional sensor data of step 208 from sensors of the sensor array 120 and/or 180 to examine conditions for automated closing of the garage door 172. In certain embodiments, the further conditions of step 224 comprise whether the vehicle 100 has exited the garage 170, and/or whether the vehicle 100 has exited the garage and travelled at least a predetermined distance away from the garage 170 and/or away form a region of interest in proximity to the garage 170 (e.g., pertaining to a portion of a driveway in proximity to the garage 170, or the like).

In various embodiments, a determination is made as to whether the further criteria for automated closing of the garage are met (step 226). In various embodiments, this determination is made by both of the processors 142 and 192 of FIG. 1 based on the determinations of step 224 (e.g., as to whether the vehicle 100 has exited the garage 170 and/or has travelled sufficiently away from the garage 170, or the like).

In various embodiments, if it is determined in step 224 that the further criteria for automated closing of the garage door 172 have not been met, then the process 200 returns to step 224, and steps 224-226 thereafter repeat in new iterations until a determination is made during an iteration of step 226 that the further criteria for automated closing of the garage door 172 has been satisfied.

Conversely, in various embodiments, once it is determined in an iteration of step 226 that the further criteria for automated closing of the garage door 172 are satisfied, then the garage door is closed (step 228). Specifically, in various embodiments, during step 226, the garage door 172 of FIG. 1 is closed by the actuators 174 of FIG. 1 in accordance with instructions provided by one or both processors. In certain embodiments, the instructions are provided by the processor 142 of the vehicle 100. In certain other embodiments, the instructions are instead provided by the processor 192 of the garage 170.

In certain embodiments, before the garage door is closed, the processor(s) may allow a user of the vehicle 100 to override the garage door automated closing action, for example by providing a notice to the user via the display system 130 of the vehicle 100 and/or via the user electronic device 105 (e.g., smart phone) of the user, and providing the user with the opportunity to confirm and/or override the automated door closing action at the user’s discretion in certain embodiments (and with the processor(s) aborting the automated door closing action if an override is provided by the user, for example, via the display system 130, the user’s electronic device 105, and/or via a voice command of the user, or the like).

In various embodiments, the process then terminates at 250.

With reference back to step 216, in various embodiments, if it is instead determined in step 216 that the vehicle 100 is physically disposed outside the garage 170, then the process proceeds instead to step 230, in which one or more outside opening criteria are examined. Specifically, in various embodiments, during step 230, one or both of the processors 142 and/or 192 utilize sensor data of step 208 from sensors of the sensor array 120 and/or 180 to examine conditions for automated opening of the garage door 172 while the vehicle 100 is disposed outside the garage 170.

In various embodiments, the outside opening criteria of step 230 include determinations as to whether the vehicle 100 is in proximity to the garage door 172, along with one or more measures of intent for the vehicle 100 and/or a user thereof to enter the garage 170. Specifically, in various embodiments, as part of step 230, the outside opening criteria includes one or more of the following: (i) whether the vehicle 100 is within a predetermined region of interest in proximity to the garage door 172 (e.g., within a portion of a driveway in proximity to the garage door 172, in certain embodiments); and/or (ii) whether the vehicle 100 operation (as tracked by one or more of the processors using the sensor data) is consistent with imminent use of and/or a request for use of the garage 170 by the vehicle 100 and/or a user thereof.

For example, in certain embodiments, such vehicle 100 operation showing intent to use the garage 170 may comprise a particular driving pattern and/or movement of the vehicle 100 from a street to the driveway to the garage door 172. In certain other embodiments, such vehicle 100 operation showing intent to use the garage 170 may also comprise a combination of the vehicle 100 moving to a particular location (e.g., a location of the driveway in proximity to the garage door 172) in combination with a predefined user action (e.g., flashing the headlights 101 of the vehicle 100) that serves as an indirect indication of the user’s intent to utilize the garage 170. In still further embodiments, such vehicle 100 operation showing intent to use the garage 170 may further comprise a combination of the vehicle 100 moving to a particular location (e.g., a location of the driveway in proximity to the garage door 172) in combination with a predefined user action that serves as a direct indication of the user’s intent to utilize the garage 170 (e.g., the user’s engagement of a garage door button 136 and/or providing a voice command to open the garage door 172, or the like). Also in certain embodiments, the intent to use the garage 170 may also be represented based on one or more other types of conditions, such as a particular day of the week and time of the day in which the vehicle 100 is usually entering the garage 170 after a vehicle drive (e.g., at the end of the workday in one example), and so on.

In various embodiments, a determination is made as to whether the outside opening criteria are met (step 232). In various embodiments, this determination is made by one or both of the processors 142 and/or 192 of FIG. 1 based on the determinations of step 230. For example, in various embodiments, if it is determined that the vehicle 100 is in proximity to the garage door 172 while a further indication of an intent to enter or use the garage 170 is also present (e.g., one or more of the types of intent as described above in connection with step 230), then in one embodiment the outside opening criteria is determined to be satisfied when it is further determined that the motor 113 of the vehicle 100 is turned on.

In various embodiments, if it is determined in step 232 that the outside opening criteria is not satisfied, then in various embodiments the process 200 returns to step 230, and steps 230-232 thereafter repeat in new iterations until a determination is made during an iteration of step 232 that the outside opening criteria is satisfied.

Conversely, in various embodiments, once it is determined in an iteration of step 232 that the outside opening criteria is satisfied, then the garage door is opened (step 234). Specifically, in various embodiments, during step 234, the garage door 172 of FIG. 1 is opened by the actuators 174 of FIG. 1 in accordance with instructions provided by one or processors. In certain embodiments, the instructions are provided by the processor 142 of the vehicle 100. In certain other embodiments, the instructions are instead provided by the processor 192 of the garage 170.

In certain embodiments, before the garage door is opened, the processor(s) may provide a user of the vehicle 100 to override the garage door automated opening action, for example by providing a notice to the user via the display system 130 of the vehicle 100 and/or via the user electronic device 105 (e.g., smart phone) of the user, and providing the user with the opportunity to confirm and/or override the automated door opening action at the user’s discretion in certain embodiments (and with the processor(s) aborting the automated door opening action if an override is provided by the user, for example, via the display system 130, the user’s electronic device 105, and/or via a voice command of the user, or the like).

In various embodiments, once the garage door 172 is opened, one or more further criteria are examined as to closing the garage door 172 (step 236). Specifically, in various embodiments, during step 224, one or both of the processors 142 and/or 192 utilize additional sensor data of step 208 from sensors of the sensor array 180 and/or 180 to examine conditions for automated closing of the garage door 172. In certain embodiments, the further conditions of step 224 comprise whether the vehicle 100 as entered the garage 170, in addition to one or more safety conditions associated with the vehicle 100. For example, in certain embodiments, the one or more safety conditions one or more of the following: (i) whether the engine (e.g., motor 113 of FIG. 1) is turned off; (ii) whether the doors 107 of FIG. 1 are closed; and (iii) whether the doors 107 are locked. In certain embodiments, the safety conditions may be satisfied based solely on the engine being turned off. In certain other embodiments, the safety conditions may be satisfied only when the motor 113 is turned off and the doors 107 are closed. In yet other embodiments, the safety conditions may be satisfied only when the motor 113 is turned off and the doors 107 are both closed and locked.

In various embodiments, a determination is made as to whether the further criteria for automated closing of the garage are met (step 238). In various embodiments, this determination is made by one or more both of the processors 142 and/or 192 of FIG. 1 based on the determinations of step 224 (e.g., as to whether the vehicle 100 has entered the garage 170 and the one or more applicable safety conditions (e.g., as described above in connection with various different embodiments) are satisfied.

In various embodiments, if it is determined in step 238 that the further criteria for automated closing of the garage door 172 have not been met, then the process 200 returns to step 236, and steps 236-28 thereafter repeat in new iterations until a determination is made during an iteration of step 238 that the further criteria for automated closing of the garage door 172 has been satisfied.

Conversely, in various embodiments, once it is determined in an iteration of step 238 that the further criteria for automated closing of the garage door 172 are satisfied, then the garage door is closed (step 240). Specifically, in various embodiments, during step 240, the garage door 172 of FIG. 1 is closed by the actuators 174 of FIG. 1 in accordance with instructions provided by one or both processors. In certain embodiments, the instructions are provided by the processor 142 of the vehicle 100. In certain other embodiments, the instructions are instead provided by the processor 192 of the garage 170.

In certain embodiments, before the garage door is closed, the processor(s) may allow a user of the vehicle 100 to override the garage door automated closing action, for example by providing a notice to the user via the display system 130 of the vehicle 100 and/or via the user electronic device 105 (e.g., smart phone) of the user, and providing the user with the opportunity to confirm and/or override the automated door closing action at the user’s discretion in certain embodiments (and with the processor(s) aborting the automated door closing action if an override is provided by the user, for example, via the display system 130, the user’s electronic device 105, and/or via a voice command of the user, or the like).

In various embodiments, the process then terminates at 250.

With reference to FIGS. 3-11, various implementations of the process 200 of FIG. 2 are depicted, in accordance with exemplary embodiments. In various embodiments, the implementations of FIGS. 3-11 include different combinations of sensors from the respective sensor arrays 120, 180 of the vehicle 100 and the garage 170, in accordance with various exemplary embodiments.

With reference to FIG. 3, an illustration 300 depicts a first exemplary implementation of the process 200. In the embodiment of FIG. 3, the vehicle 100 is initially disposed outside the garage 170. Also in the embodiment of FIG. 3, the vehicle 100 includes UWB sensors 124, and the garage 170 also includes UWB sensors 184, that communicate with one another. As shown in FIG. 3, in an exemplary embodiment, the garage door 172 is automatically opened at 302 after the successful authentication of the vehicle 100 and that the vehicle is disposed within a particular zone or location of interest (e.g., inside a driveway in proximity to the garage door 172), based on information obtained the respective sensors 124, 184 that are depicted in FIG. 3. In various embodiments, once this is confirmed and the garage door 172 opens at 302, the vehicle 100 travels into the garage 170 at 304 as illustrated in FIG. 3. As noted above, in the embodiment of FIG. 3 both the vehicle 100 and the garage 170 have respective UWB sensors 124, 184 that communicate with one another, and so that RF sensors are not required in this embodiment. In certain other embodiments (such as certain embodiments described further below), the vehicle 100 and the garage 170 may also include RF sensors and/or other sensors, in addition to their respective UWB sensors 124, 184.

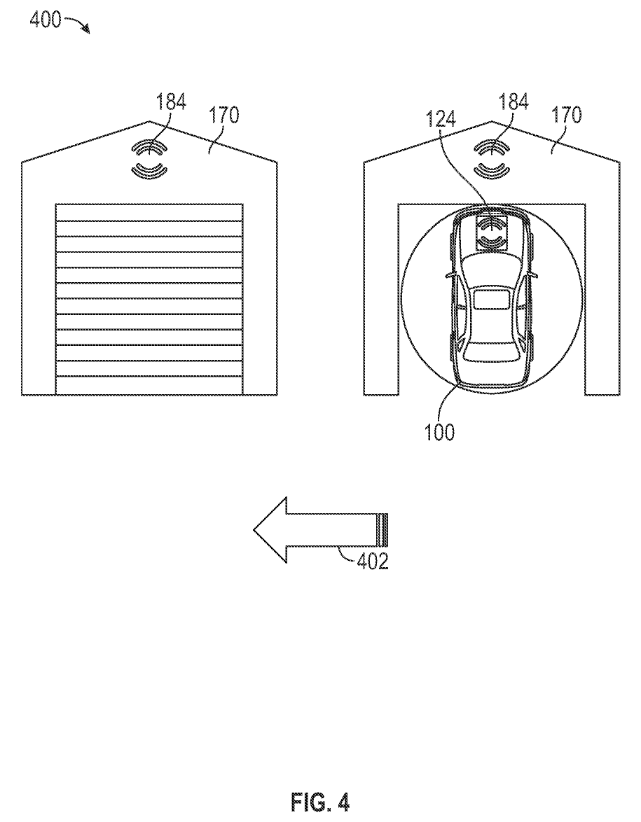

With reference to FIG. 4, an illustration 400 depicts a continuation of the example of FIG. 3, but taking place after the vehicle 100 has entered the garage 170 after the garage door 172 has been automatically opened. In the embodiment of FIG. 4, once the vehicle 100 is confirmed as being disposed inside the garage 170 and one or more safety features are determined to be satisfied (e.g., the motor 113 being turned off, and the doors 107 being closed and locked), the garage door 172 is then automatically closed at 402.

With reference to FIG. 5, an illustration 500 depicts an additional exemplary implementation of the process 200. In the embodiment of FIG. 5, the vehicle 100 is initially disposed outside the garage 170. Also in the embodiment of FIG. 5, the vehicle 100 includes both UWB sensors 124 and RF sensors 125, and the garage 170 includes RF sensors 185 and one or more UWB sensors 184 acting as UWB anchors 187. In certain embodiments, the anchors 187 may be provided inside the garage 170 and/or garage door 172, whereas in certain other embodiments the anchors 187 may be provided outside the garage 170 and/or garage door 172. In various embodiments, the various sensors of the vehicle 100 and the garage 170 as depicted in FIG. 5 communicate with one another. As shown in FIG. 5, in an exemplary embodiment, the garage door 172 is automatically opened at 502 after the successful authentication of the vehicle 100 and that the vehicle is disposed within a particular zone or location of interest (e.g., inside a driveway in proximity to the garage door 172) and further that motion patterns of the vehicle 100 are satisfied with respect to an intent to enter the garage 170 (e.g., as described in greater detail above in connection with FIG. 2 in exemplary embodiments), based on information obtained the respective sensors 124, 125, 184, 185 that are depicted in FIG. 5 along with the anchors 187 as depicted in FIG. 5. In various embodiments, once this is confirmed and the garage door 172 opens at 502, the vehicle 100 travels into the garage 170 at 504 as illustrated in FIG. 5.

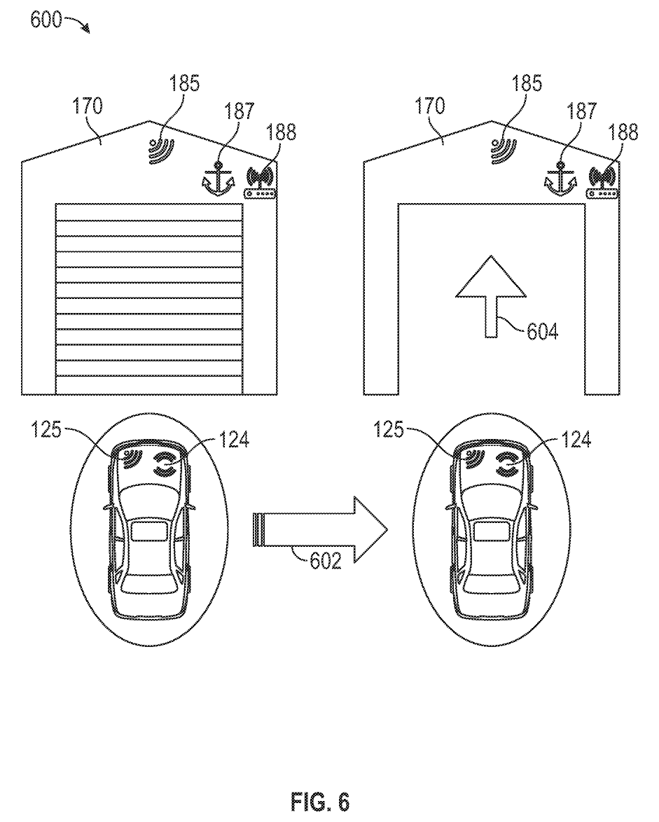

With reference to FIG. 6, an illustration 600 depicts an additional exemplary implementation of the process 200. In the embodiment of FIG. 6, the vehicle 100 is initially disposed outside the garage 170. Also in the embodiment of FIG. 6, the vehicle 100 includes both UWB sensors 124 and RF sensors 125, and the garage 170 includes RF sensors 185, one or more UWB sensors 184 acting as UWB anchors 187, and a bridge 188 (e.g., an RF-UWB that facilitates communications between RF sensors and UWB sensors). In certain embodiments, the anchors 187 and/or bridge 188 may be provided inside the garage 170 and/or garage door 172, whereas in certain other embodiments the anchors 187 and/or bridge 188 may be provided outside the garage 170 and/or garage door 172. In various embodiments, the various sensors of the vehicle 100 and the garage 170 as depicted in FIG. 6 communicate with one another. As shown in FIG. 6, in an exemplary embodiment, the garage door 172 is automatically opened at 602 after the successful authentication of the vehicle 100 and that the vehicle is disposed within a particular zone or location of interest (e.g., inside a driveway in proximity to the garage door 172) and further that motion patterns of the vehicle 100 are satisfied with respect to an intent to enter the garage 170 (e.g., as described in greater detail above in connection with FIG. 2 in exemplary embodiments), based on information obtained the respective sensors 124, 125, 185 that are depicted in FIG. 6 along with the anchors 187 and bridge 188 as depicted in FIG. 6. In various embodiments, once this is confirmed and the garage door 172 opens at 602, the vehicle 100 travels into the garage 170 at 604 as illustrated in FIG. 5.

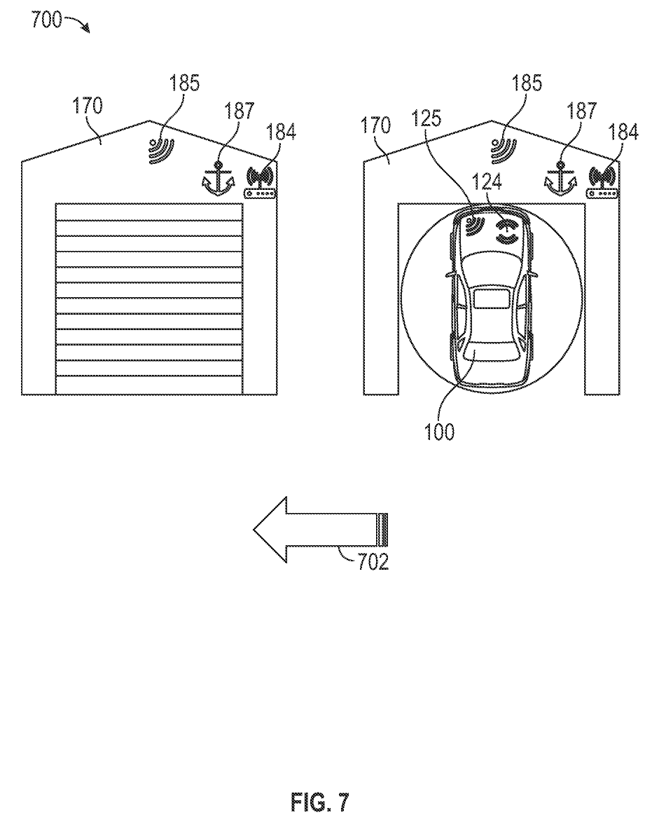

With reference to FIG. 7, an illustration 700 depicts an extension of the exemplary implementation of FIG. 5, depicted after the vehicle 100 enters the garage 170. In the embodiment of FIG. 7, the vehicle 100 (similar to the embodiment of FIG. 5) includes both UWB sensors 124 and RF sensors 125, and the garage 170 includes RF sensors 185 and one or more UWB sensors 184 acting as UWB anchors 187. In certain embodiments, the anchors 187 may be provided inside the garage 170 and/or garage door 172, whereas in certain other embodiments the anchors 187 may be provided outside the garage 170 and/or garage door 172. In various embodiments, the various sensors of the vehicle 100 and the garage 170 as depicted in FIG. 7 communicate with one another. As shown in FIG. 7, in an exemplary embodiment, once the vehicle 100 is determined to have entered the garage 170, in combination with one or more safety conditions being satisfied (e.g., including the motor 113 being turned off and the doors 107 closed and locked), then the garage door 172 is automatically closed at 702.

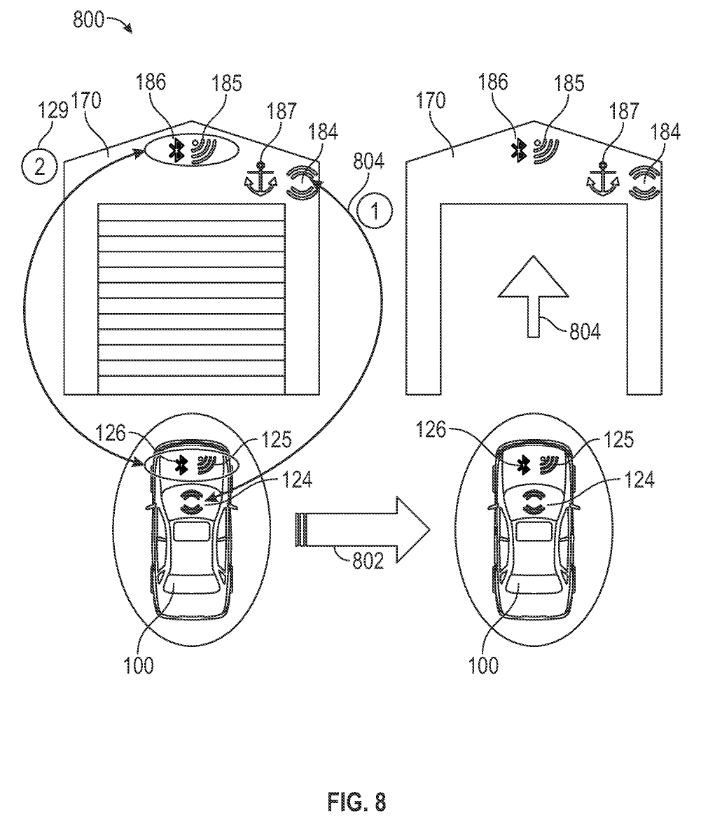

With reference to FIG. 8, an illustration 800 depicts an additional exemplary implementation of the process 200. In the embodiment of FIG. 8, the vehicle 100 is initially disposed outside the garage 170. Also in the embodiment of FIG. 8, the vehicle 100 includes UWB sensors 124, RF sensors 125, and SRW sensors 126, and the garage 170 includes UWB sensors 124, RF sensors 185, and SRW sensors 186 along with one or more UWB sensors 184 acting as UWB anchors 187). In certain embodiments, the anchors 187 may be provided inside the garage 170 and/or garage door 172, whereas in certain other embodiments the anchors 187 may be provided outside the garage 170 and/or garage door 172. In various embodiments, the various sensors of the vehicle 100 and the garage 170 as depicted in FIG. 8 communicate with one another. Also in the embodiment of FIG. 8, a link 129 (e.g., as previously established via an initial pairing) is present for various of the respective sensors of the vehicle 100 and the garage 170, and is utilized for the authentication and ranging for the steps of the process 200 for this particular implementation. As shown in FIG. 8, in an exemplary embodiment, the garage door 172 is automatically opened at 802 after the successful authentication of the vehicle 100 and that the vehicle is disposed within a particular zone or location of interest (e.g., inside a driveway in proximity to the garage door 172) and further that motion patterns of the vehicle 100 are satisfied with respect to an intent to enter the garage 170 (e.g., as described in greater detail above in connection with FIG. 2 in exemplary embodiments), based on information obtained the respective sensors (and including the link 129 therebetween) that are depicted in FIG. 8 along with the anchors 187 as depicted in FIG. 8. In various embodiments, once this is confirmed and the garage door 172 opens at 802, the vehicle 100 travels into the garage 170 at 804 as illustrated in FIG. 8.

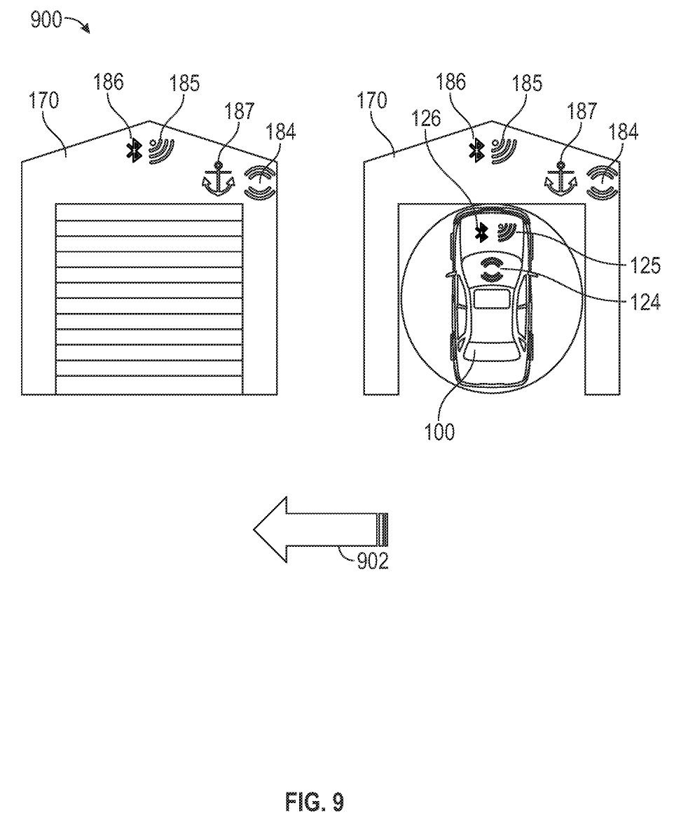

With reference to FIG. 9, an illustration 900 depicts an extension of the exemplary implementation of FIG. 8, depicted after the vehicle 100 enters the garage 170. In the embodiment of FIG. 9, once the vehicle 100 is determined to have entered the garage 170, in combination with one or more safety conditions being satisfied (e.g., including the motor 113 being turned off and the doors 107 closed and locked), then the garage door 172 is automatically closed at 902.

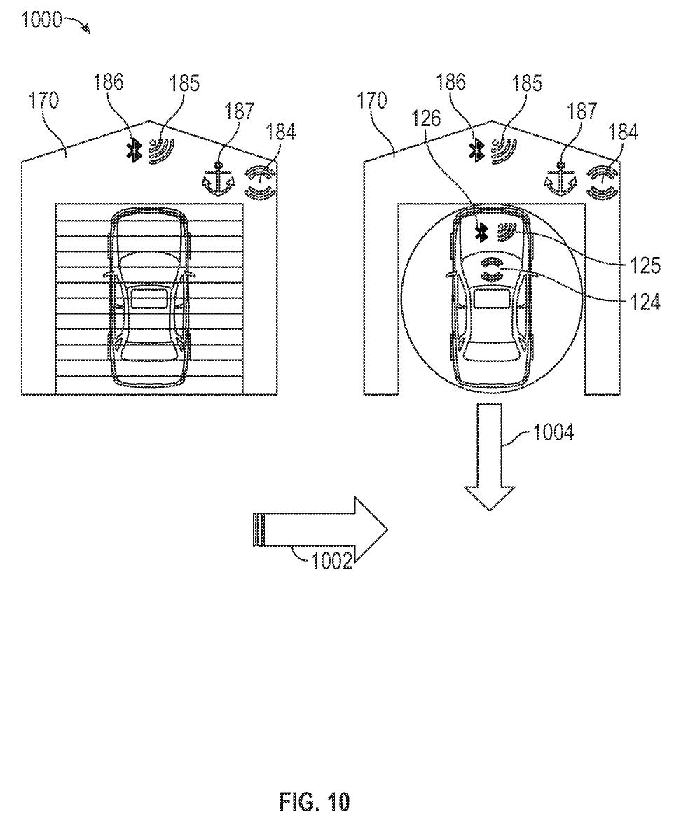

With reference to FIG. 10, an illustration 1000 depicts a further extension of the exemplary implementations of FIGS. 8 and 9, depicted while the vehicle 100 is disposed inside the garage 170 with the garage door 172 closed, and in which the vehicle 100 is ready to exit the garage 170. In the embodiment of FIG. 10, once the vehicle 100 is determined to be ready to exit the garage 170 (e.g., once the motor 113 is turned on, in certain embodiments), then the garage door 172 is automatically opened at 1002.

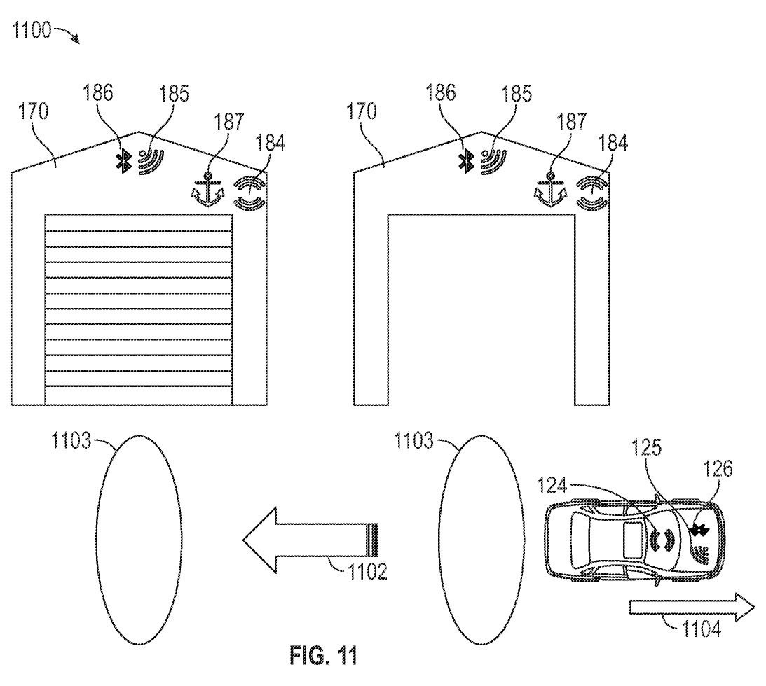

With reference to FIG. 11, an illustration 1100 depicts a further extension of the exemplary implementations of FIGS. 8-10, depicted while the vehicle 100 has travelled outside the garage 170 once the garage door 172 is opened. In the embodiment of FIG. 11, once the vehicle 100 is determined to have exited the garage 170 and has driven away from one or more zones of interest 1103 (e.g., pertaining to a driveway in proximity to the garage 170), in certain embodiments) the garage door 172 is automatically closed at 1102.

Accordingly, methods, systems, and vehicles are disclosed for automatically opening and closing of garage doors for vehicles. Specifically, in various embodiments, one or more processors utilize sensor data from one or more sensors in order to determine appropriate conditions for automatically opening and closing the door in connection with various implementations and circumstances, as depicted in the Figures and as described above in greater detail in connection therewith. In various embodiments, the techniques disclosed herein (including of the process 200 of FIG. 2 and the implementations of FIGS. 3-11) may similarly be applied in one or more other contexts, such as in storage lockers and/or one or more other types of non-mobile and/or mobile platforms.

It will be appreciated that the systems, vehicles, and methods may vary from those depicted in the Figures and described herein. For example, the vehicle 100, the control system 102 thereof and other components thereof, the garage 170 and components thereof, and other components of the system 10 of FIG. 1 may vary in different embodiments. It will similarly be appreciated that the steps of the process 200 may differ from that depicted in FIGS. 2, and/or that various steps of the process 200 may occur concurrently and/or in a different order than that depicted in FIG. 2. It will also be appreciated that the implementations of FIGS. 3-11 may also vary in different embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling automated operation of a garage door of a garage, the method comprising:
obtaining, via one or more sensors, sensor data as to a vehicle in proximity to the garage door;
performing authentication of the vehicle as being associated with the garage, via a processor coupled to the one or more sensors and using the sensor data;
performing ranging of the vehicle in proximity to the garage, via the processor using the sensor data; and
automatically opening and closing the garage door, via instructions provided by the processor to an actuator and that are implemented via the actuator, based on the authentication and the ranging of the vehicle via the processor based on the sensor data.

2. The method of claim 1, wherein the one or more sensors comprise sensors from both the vehicle and the garage.

3. The method of claim 1, further comprising:
determining, via the processor using the sensor data and based on the ranging, whether the vehicle is disposed in the garage;
automatically opening the garage based on inside opening criteria, via instructions provided by the processor to the actuator, when it is determined that the vehicle is disposed in the garage;
automatically opening the garage based on outside opening criteria that is different from the inside opening criteria, via instructions provided by the processor to the actuator, when it is determined that the vehicle is disposed outside the garage;
automatically closing the garage based on inside closing criteria, via instructions provided by the processor to the actuator, when it is determined that the vehicle is disposed in the garage; and
automatically closing the garage based on outside closing criteria that is different from the inside closing criteria, via instructions provided by the processor to the actuator, when it is determined that the vehicle is disposed outside the garage.

4. The method of claim 3, wherein:
the inside opening criteria is based on one or more security requirements of the vehicle; and
the outside opening criteria is based on the vehicle being in proximity to the garage door in addition to one or more indications of intent of the vehicle or a user of the vehicle to enter the garage.

5. The method of claim 4, wherein:
the one or more security requirements of the inside opening criteria comprise a motor of the vehicle being turned on while the vehicle is inside the garage; and
the one or more indications of intent of the outside opening criteria comprise the vehicle being in a region of interest in a driveway in proximity to the garage.

6. The method of claim 5, wherein the one or more indications of intent of the outside opening criteria further comprise the vehicle moving in a pattern from a roadway toward the garage via the driveway.

7. The method of claim 6, wherein the one or more indications of intent of the outside opening criteria further comprise the user of the vehicle taking one or more predefined actions with respect to a garage opening button, flashing of headlights of the vehicle, or both.

8. The method of claim 3, wherein:
the inside closing criteria are based on one or more security requirements of the vehicle, including whether a motor of the vehicle is turned off; and
the outside closing criteria is based on the vehicle having exited the garage and travelling outside a region of interest in proximity to the garage.

9. The method of claim 8, wherein the one or more security requirements of the inside closing criteria further comprise doors of the vehicle being closed, locked, or both.

10. A system for controlling automated operation of a garage door of a garage, the system comprising:
one or more sensors configured to obtain sensor data as to a vehicle in proximity to the garage door; and
a processor that is coupled to the one or more sensors and that is configured to at least facilitate:
performing authentication of the vehicle as being associated with the garage, using the sensor data;
performing ranging of the vehicle in proximity to the garage, using the sensor data; and
automatically opening and closing the garage door, via instructions provided by the processor to an actuator and that are implemented via the actuator, based on the authentication and the ranging of the vehicle based on the sensor data.

11. The system of claim 10, wherein the one or more sensors comprise sensors from both the vehicle and the garage.

12. The system of claim 10, wherein the processor is further configured to at least facilitate:
determining, using the sensor data and based on the ranging, whether the vehicle is disposed in the garage;
automatically opening the garage based on inside opening criteria, via instructions provided by the processor to the actuator, when it is determined that the vehicle is disposed in the garage;
automatically opening the garage based on outside opening criteria that is different from the inside opening criteria, via instructions provided by the processor to the actuator, when it is determined that the vehicle is disposed outside the garage;
automatically closing the garage based on inside closing criteria, via instructions provided by the processor to the actuator, when it is determined that the vehicle is disposed in the garage; and
automatically closing the garage based on outside closing criteria that is different from the inside closing criteria, via instructions provided by the processor to the actuator, when it is determined that the vehicle is disposed outside the garage.

13. The system of claim 12, wherein:
the inside opening criteria is based on one or more security requirements of the vehicle; and
the outside opening criteria is based on the vehicle being in proximity to the garage door in addition to one or more indications of intent of the vehicle or a user of the vehicle to enter the garage.

14. The system of claim 13, wherein:
the one or more security requirements of the inside opening criteria comprise a motor of the vehicle being turned on while the vehicle is inside the garage; and
the one or more indications of intent of the outside opening criteria comprise the vehicle being in a region of interest in a driveway in proximity to the garage.

15. The system of claim 14, wherein the one or more indications of intent of the outside opening criteria further comprise the vehicle moving in a pattern from a roadway toward the garage via the driveway.

16. The system of claim 15, wherein the one or more indications of intent of the outside opening criteria further comprise the user of the vehicle taking one or more predefined actions with respect to a garage opening button, flashing of headlights of the vehicle, or both.

17. The system of claim 12, wherein:
the inside closing criteria are based on one or more security requirements of the vehicle, including whether a motor of the vehicle is turned off; and
the outside closing criteria is based on the vehicle having exited the garage and travelling outside a region of interest in proximity to the garage.

18. The system of claim 17, wherein the one or more security requirements of the inside closing criteria further comprise doors of the vehicle being closed, locked, or both.

19. A system comprising:
a garage comprising:
a garage door;
an actuator configured to open and close the garage door; and
a garage sensor array configured to obtain garage sensor data;
a wireless communications system; and
a vehicle configured to be coupled to the garage via the wireless communications system, the vehicle comprising:
a body;
a plurality of doors;
a plurality of wheels;
a drive system including a motor and configured to move the body via the plurality of wheels; and
a vehicle sensor array that is configured to obtain vehicle sensor data;
wherein the garage, the vehicle, or both further comprise one or more processors that are coupled to the garage sensor array and that are configured to at least facilitate:
performing authentication of the vehicle as being associated with the garage, using the garage sensor data and the vehicle sensor data;
performing ranging of the vehicle in proximity to the garage, using the garage sensor data and the vehicle sensor data;
determining, using the sensor data and based on the ranging, whether the vehicle is disposed in the garage; and
automatically opening and closing the garage door, via instructions provided by the one or more processors to the actuator and that are implemented via the actuator, based on the authentication and the ranging of the vehicle based on the sensor data, including by:
automatically opening the garage based on inside opening criteria based on one or more security requirements of the vehicle including the motor of the vehicle being turned off, via instructions provided by the one or more processors to the actuator, when it is determined that the vehicle is disposed in the garage;
automatically opening the garage based on outside opening criteria that is different from the inside opening criteria and that is based on the vehicle being in proximity to the garage door in addition to one or more indications of intent of the vehicle or a user of the vehicle to enter the garage, via instructions provided by the one or more processors to the actuator, when it is determined that the vehicle is disposed outside the garage;
automatically closing the garage based on inside closing criteria, via instructions provided by the one or more processors to the actuator based on the one or more security requirements of the vehicle, including the motor of the vehicle being turned off, when it is determined that the vehicle is disposed in the garage; and
automatically closing the garage based on outside closing criteria that is different from the inside closing criteria based on the vehicle having exited the garage and travelling outside a region of interest in proximity to the garage, via instructions provided by the one or more processors to the actuator, when it is determined that the vehicle is disposed outside the garage.

20. The system of claim 19, wherein
the one or more indications of intent of the outside opening criteria further comprise the vehicle moving in a pattern from a roadway toward the garage via the driveway, and the user of the vehicle taking one or more predefined actions with respect to a garage opening button, flashing of headlights of the vehicle, or both; and
the one or more security requirements of the inside closing criteria further comprise the plurality of doors of the vehicle being closed, locked, or both.
